(19) United States
(12) Patent Application Publication
(10) Pub. No.: US 2026/0175953 A1
(43) Pub. Date: Jun. 25, 2026

(54) SAIL FOR A KITE FOR PULLING ALONG A FLOATING CRAFT OR A LAND VEHICLE

(71) Applicant: OCEA, Arcachon (FR)

(72) Inventors: Yves Parlier, Arcachon (FR); Eric Pelaprat, Lavérune (FR)

(73) Assignee: OCEA, Arcachon (FR)

(21) Appl. No.: 18/856,638

(22) PCT Filed: Apr. 14, 2023
(86) PCT No.: PCT/EP2023/059853

§ 371 Date: Oct. 14, 2024

(30) Foreign Application Priority Data
Apr. 14, 2022 (FR) FR2203492

(51) Int. Cl. B63H 9/072; B60K 8/00; B63H 9/067

(52) U.S. Cl. CPC B63H 9/072; B60K 8/00; B63H 9/067

(57) ABSTRACT

The sail (5) for a kite (4) of a device (3) for pulling along a floating craft or a rolling and/or sliding land vehicle, in particular a flexible sail (5) with boxes, in particular with open or closed boxes, or with a simple skin, or with double surfaces, has cords or bridles which distribute a pulling force across a plurality of points attached to the lower surface of the sail. The sail extends over a length l. The sail (5) has retaining points (210) intended to cooperate with a launching line (20) to facilitate launching of the sail (5).

### TECHNICAL FIELD OF THE INVENTION

The invention concerns a sail for a kite of a traction device for pulling along a floating craft or a rolling and/or sliding land vehicle. The invention also concerns a traction device comprising such a sail. The invention also concerns a floating craft or a rolling and/or sliding land vehicle comprising such a traction device or such a sail. The invention also concerns a method for operating such a traction device. The invention also concerns a traction device comprising hardware and/or software elements for implementing such a method. The invention also concerns a computer program comprising code instructions for implementing such a method. The invention also concerns a data recording medium for implementing such a method. The invention also concerns a signal of a data medium carrying such a computer program.

### BACKGROUND ART

A kite for pulling along a floating craft, such as for example a boat or ship, requires delicate operation during its launch from a bridge of the floating craft. Consequently, there are significant risks of seeing the kite being damaged in the sea or in contact with the floating craft or the ground during the maneuvers. Conventional launching of this type of kite requires an inflation phase and the complete unwinding of lines intended to connect it mechanically to the floating craft. This is possible on land but much more difficult at sea. One solution is to allow the kite to drift on the surface of the water, and lift it off once the lines have unwound. Another solution is to use a specific craft for lifting it into wind, and-a fortiori-for recovering it. Other solutions use a launch mast for raising and holding the kite during its lift-off phase, but variations in the wind caused by movements of the ship disrupt the inflation and lift-off. Such solutions are not satisfactory.

### SUMMARY OF THE INVENTION

The invention concerns a sail which enables the above drawbacks to be remedied. In particular, the invention allows the omission of a kite launching mast, and secures and stabilizes the flight of the kite during this critical phase of lift-off and climbing to the altitude necessary for pulling along a floating craft or a rolling and/or sliding land vehicle.

To achieve this object, the invention concerns a sail for a kite of a traction device for pulling along a floating craft or a rolling and/or sliding land vehicle, in particular a flexible sail with boxes, in particular with open or closed boxes, or with a single skin, or with double surfaces, in particular a sail having rigging lines or straps which distribute a traction force over a plurality of points attached to the lower surface of the sail, the sail extending over a length, the sail comprising retaining points intended to cooperate with a launching line to facilitate lift-off of the sail.

The retaining points may be distributed along the length of the sail, in particular distributed regularly.

The sail may comprise a leading edge and the retaining points may be arranged in a lower zone of the leading edge.

The sail may comprise a sliding means for such a launching line at each retaining point, in particular an eyelet or spring hook or a loop or a pulley.

The sail may comprise a first anchoring point of the sail and a second anchoring point of the sail, in particular a first and a second anchoring point of the sail arranged substantially at the ends of the sail along its length.

The invention furthermore concerns a traction device for pulling along a floating craft or a rolling and/or sliding land vehicle, comprising a sail as defined above, the traction device comprising:
a launching line,
a first control line of the sail connected to the first anchoring point of the sail,
a second control line of the sail connected to the second anchoring point of the sail,
   the launching line passing through each retaining point and/or being fixed in jettisonable fashion to each retaining point.

The invention furthermore concerns a traction device for pulling along a floating craft or a rolling and/or sliding land vehicle, comprising a sail as defined above, the traction device comprising:
a single launching line,
a first control line of the sail connected to the first anchoring point of the sail,
a second control line of the sail connected to the second anchoring point of the sail,
   the single launching line passing through each retaining point and/or being fixed in jettisonable fashion to each retaining point.

The invention furthermore concerns a traction device for pulling along a floating craft or a rolling and/or sliding land vehicle, comprising a sail as defined above, the traction device comprising:
a single launching line,
a first control line of the sail connected to the first anchoring point of the sail,
a second control line of the sail connected to the second anchoring point of the sail,
   the single launching line being able to join each retaining point.

The traction device may comprise a plate, in particular a plate comprising at least one pulley block and/or holes through which the launching line passes.

The invention furthermore concerns a floating craft comprising a traction device as defined above, comprising a bridge comprising a first means for attaching the first control line and a second means for attaching the second control line, the first attachment means and the second attachment means being spaced apart from one another by a given value, in particular by plus or minus 20 percent of two-thirds of the length of the sail.

The invention furthermore concerns a rolling and/or sliding land vehicle comprising a traction device as defined above, comprising a frame comprising a first means for attaching the first control line and a second means for attaching the second control line, the first attachment means and the second attachment means being spaced apart from one another by a given value, in particular by plus or minus 20 percent of two-thirds of the length of the sail.

The invention furthermore concerns a method of operation of a traction device as defined above, the method comprising the following steps:
retaining the sail on the floating craft or on the vehicle via the first anchoring point and via at least the retaining point closest to the first anchoring point, preferably retaining the sail on the floating craft or on the vehicle via an anchoring point and via all retaining points,
loosening the sail so as to progressively release it at the retaining points such that the sail inflates and/or lifts off, the release being achieved progressively, one retaining point after another retaining point, moving away from the first anchoring point and drawing closer to the second anchoring point, until the sail is retained only by the first and second anchoring points.

The loosening may be controlled, in particular by an automatic friction means or by an automatic speed control means or by a manual means or by a brake.

The traction device may comprise hardware and/or software elements implementing the method as defined above, in particular hardware and/or software elements designed to implement the method as defined above, and/or the device may comprise means for implementing the method as defined above.

The invention furthermore concerns a computer program product comprising program code instructions recorded on a computer-readable medium for implementing the steps of the method as defined above when said program runs on a computer, or a computer program product downloadable from a communication network and/or recorded on a computer-readable data medium and/or able to be executed by a computer, comprising instructions which, when the program is executed by the computer, lead the latter to implement the method as defined above.

The invention furthermore concerns a data recording medium, readable by a computer, on which a computer program is recorded which comprises program code instructions for implementing the method as defined above, or a data recording medium, readable by a computer, comprising instructions which, when executed by a computer, lead the latter to implement the method as defined above.

The invention furthermore concerns a signal of a data medium carrying the computer product program as defined above.

### BRIEF DESCRIPTION OF THE DRAWINGS

Further advantages and characteristics will arise more clearly from the description below of an embodiment of a sail of a kite for a floating craft or a rolling and/or sliding land vehicle, and of a mode for implementation of an operating method of a traction device, and the appended figures in which:

FIG. 1 is a partial, schematic view of a floating craft according to an embodiment.

FIG. 2 is a schematic view of a rolling and/or sliding land vehicle according to an embodiment.

FIG. 3 is a sectional, schematic view of a sail of a kite with a single skin according to the embodiment.

FIG. 4 is a sectional, schematic view of a sail of a kite with a double skin according to the embodiment.

FIG. 5 is a sectional, schematic view of a sail of a hybrid kite according to the embodiment.

FIG. 6 is a view from below of a sail according to the embodiment.

FIG. 7 is a view of a traction device according to an embodiment during lift-off of the sail of the kite.

FIG. 8 is a view of a first launching phase of the sail according to the embodiment.

FIG. 9 is a view of a second launching phase of the sail according to the embodiment.

FIG. 10 is a view of a third launching phase of the sail according to the embodiment.

FIG. 11 is a view of a fourth launching phase of the sail according to the embodiment.

FIG. 12 is a view of a fifth launching phase of the sail according to the embodiment.

FIG. 13 shows a superposition of launching phases of a sail according to a variant embodiment.

### DETAILED DESCRIPTION OF PARTICULAR EMBODIMENTS

The direction in which a floating craft moves in a straight line, in a plane parallel to the water level of a body of water, is defined as being the longitudinal direction. By convention, the direction perpendicular to the longitudinal direction, situated in a plane parallel to the water level of a body of water, is called the transverse direction. The third direction, perpendicular to the two others, is called the vertical direction.

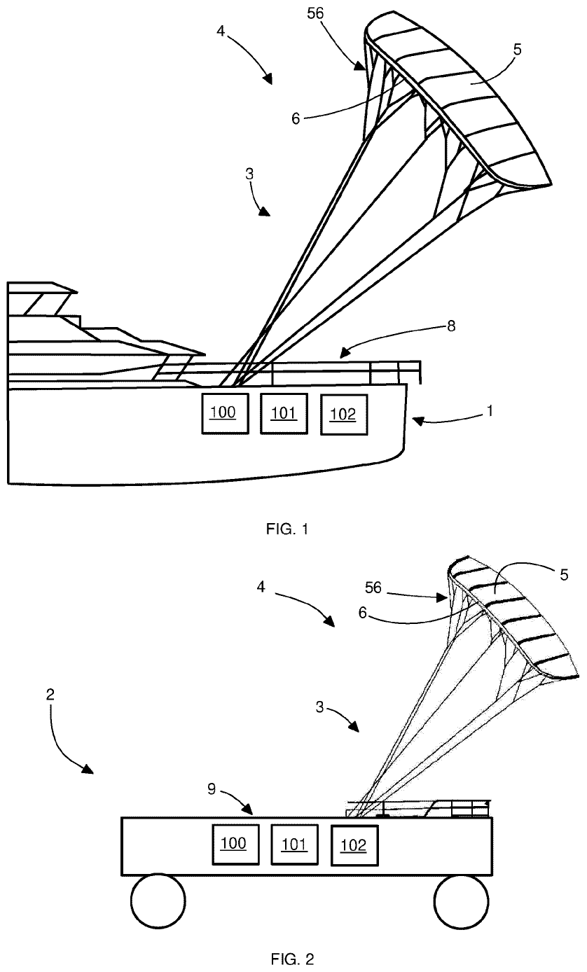

FIG. 1 illustrates schematically a floating craft 1. Such a floating craft 1 is for example a boat or ship.

FIG. 2 illustrates schematically a rolling and/or sliding land vehicle 2. Such a vehicle is for example a vehicle intended to be used on an extent of frozen water and/or on sand and/or on snow and/or on grass and/or on soil.

The floating craft 1 or the rolling and/or sliding land vehicle 2 comprises a traction device 3.

The traction device 3 comprises a kite 4. The kite 4 comprises or includes a sail 5. The sail 5 is equipped with a leading edge 6 or comprises a leading edge 6.

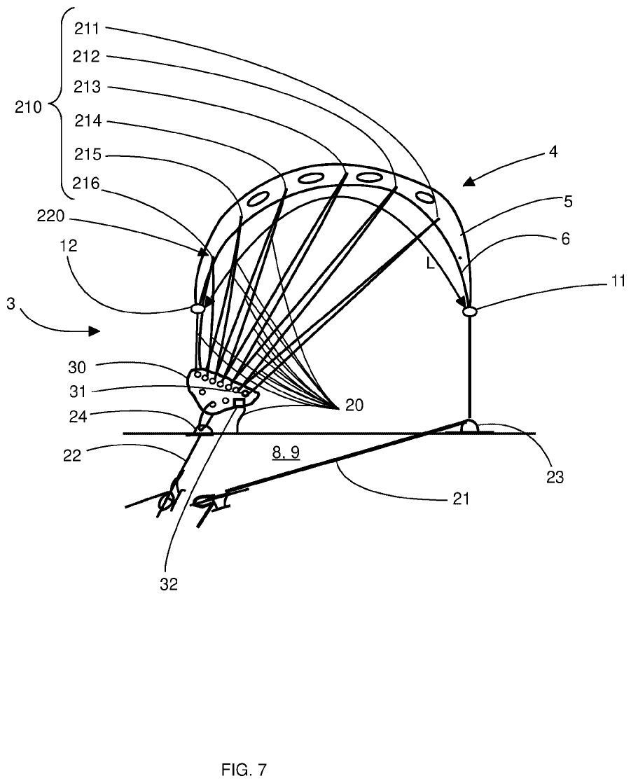

The traction device 3 of the floating craft 1 or rolling and/or sliding land vehicle 2 also comprises a launching line 20, illustrated in particular on FIG. 7. The traction device 3 furthermore comprises a first anchoring point 11 of the sail 5 and a second anchoring point 12 of the sail 5. The traction device 3 furthermore comprises a first control line 21 of the sail 5, which is connected to the first anchoring point 11 of the sail 5, and a second control line 22 of the sail 5, which is connected to the second anchoring point 12 of the sail 5.

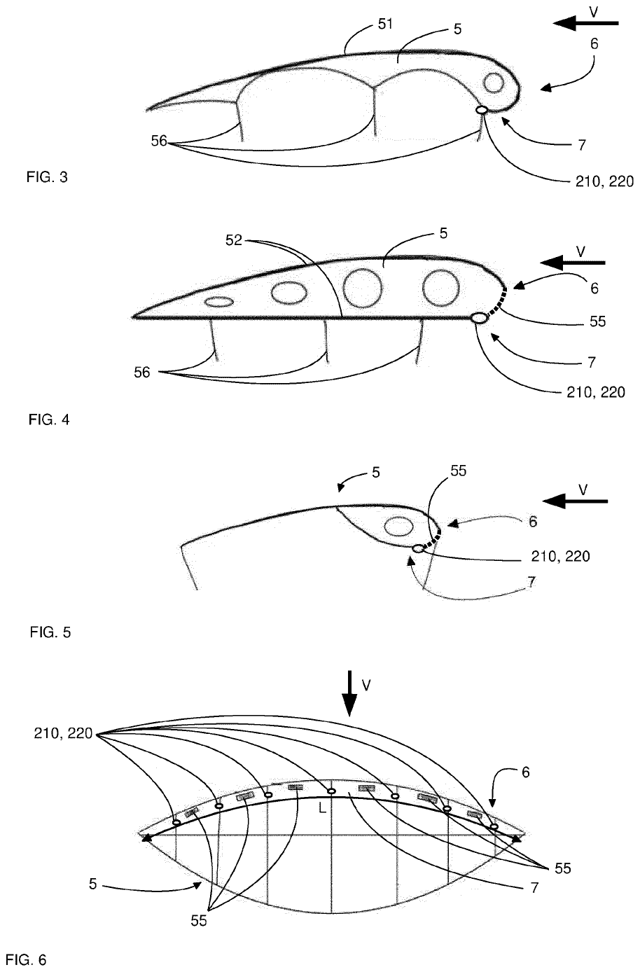

As illustrated on FIG. 3, the sail 5 is for example of the mono-skin or single skin type 51. In this case, the only skin 51 extends to form the upper surface and the leading edge 6.

As illustrated on FIG. 4, the sail 5 is for example of the double skin or double surface type 52. In this case, for example, one skin extends to form the upper surface and another skin extends to form the lower surface. For example, these two skins meet and thus form only a single skin delimiting a volume between them. The skin of the lower surface and/or the skin of the upper surface forms the leading edge 6.

As illustrated on FIG. 5, the sail 5 is for example of the hybrid type, namely comprising a main skin forming the upper surface and a secondary skin forming the volume of the leading edge on the lower surface. For example, these two skins meet before the trailing edge and thus form only a single skin delimiting a volume between them.

For example, the sail 5 comprises boxes or cells or compartments. As illustrated on FIGS. 4, 5 and 6, air inlets 55 may be provided at the leading edge 6 so as to supply air to the cells, in particular taking account of the flow of air or wind V (arrow). Also, such cells may be opened or closed, in particular by means of valves or flaps (not shown).

In some cases, the sail 5 or the kite 4 comprises rigging lines 56, in particular of the cord type, which may be connected together by one or more straps.

Preferably, the sail 5 is flexible.

More precisely, as illustrated on FIGS. 6 and 7 by a double arrow, the sail 5 extends over a length L.

The sail 5 also comprises retaining points 210, illustrated in particular on FIGS. 3, 4, 5, 6 and 7. The retaining points 210 are intended to cooperate with a launching line 20. The cooperation of the retaining points with the launching line 20 facilitates the lift-off of the sail 5 of the kite, as will be seen below. Preferably, the retaining points 210 are distributed along the length L of the sail 5. For example, the retaining points 210 are regularly distributed along the length L.

The term “regularly” means that, in the case of n retaining points to be distributed over the length L, the length L is divided into n+1 segments or arcs of the same length, allowing positioning of the locations of the n retaining points. Preferably, no retaining point is provided at each end of the length L. In fact, preferably, anchoring points 11, 12 are provided at the ends of the sail or close to the end of the sail.

More precisely, as illustrated on FIGS. 3, 4, 5 and 6, the leading edge 6 comprises a lower zone 7. The retaining points 210 are preferably arranged in the retaining zone 7 of the leading edge 6. The retaining or attachment points 210 for launching are substantially arranged over a front quarter of the lower surface profile, i.e. the first quarter relative to the wind direction V. In the case of an air inlet 55 as illustrated on FIGS. 4, 5 and 6, the retaining points are arranged behind the air inlets relative to the wind direction V.

As illustrated on FIGS. 3, 4, 5, 6 and 7, the sail 5 comprises a sliding means 220 at each retaining point 210. In other words, the attachment points 210 are equipped with a sliding means 220 so as to allow sliding of the launching rigging lines. Each sliding means 220 allows passage of the launching line 20 where necessary. For example, the sliding means 220 is or comprises an eyelet, a spring hook, a loop, a friction ring, a twin cone or a pulley.

As illustrated on FIG. 7, the sail 5 comprises the first anchoring point 11 of the sail 5 and the second anchoring point 12 of the sail 5. Preferably, the first and second anchoring points 11, 12 of the sail are arranged substantially at the ends of the sail 5 along its length L.

Advantageously, a single launching line 20 joins the retaining points 210, for example by doubling back and/or joining them by a tie or set of ties. In other words, the single launching line 20 passes through each retaining point 210, and/or joins each retaining point. The single launching line 20 is fixed, or may be fixed, in jettisonable fashion to each retaining point 210 or at each retaining point. In the case of sliding means 220, the launching line 20 slides in each sliding means.

Preferably, as illustrated on FIG. 7, the traction device 3 comprises a plate or tie 30. For example, the plate 30 comprises at least one pulley block and/or holes through which the launching line 20 passes. The launching line 20 is for example fixed to the plate 30 at one end of the launching line 20, while the rest of the launching line remains free. Thus the free part of the launching line joins a retaining point 216, then returns to the plate 30, then joins a retaining point 215, then returns to the plate 30, then joins a retaining point 214, then returns to the plate 30, then joins a retaining point 213, then returns to the plate 30, then joins a retaining point 212, then returns to the plate 30, then joins a retaining point 211, then returns to the plate 30, extending with sufficient length for an operator or actuator 32 to be able to release it bit by bit so as to ensure a gentle lift-off of the sail 5. For example, a hole or eyelet or loop or pulley 31 is arranged on the plate 30 to ensure deployment or loosening of the length of the launching line during lift-off. In other words, the launching line or lines connect the launching points 210 to the plate 30 for concentration and/or reeving of the launching line or lines. In the case of a single continuous launching line, this is fixed to the plate and extends from the plate to a first launching point, returns to the plate before joining a second launching point, and so on until the nth launching point, before joining the plate and passing through it so as to be able to slacken the continuous line, as will be shown below.

As illustrated on FIGS. 1, 2 and 7, the floating craft or rolling and/or sliding land vehicle comprising the traction device 3 furthermore comprises a bridge 8 or a frame 9 respectively. The bridge or frame comprises a first attachment means 23 for the first control line 21 and a second attachment means 24 for the second control line 22. Preferably, the first attachment means 23 and the second attachment means 24 are spaced apart from one another by two-thirds of the length L or of the span of the sail 5, or at least by plus or minus 20 percent of the two-thirds of the length L. Preferably, an axis passing through the first attachment means 23 and the second attachment means 24 fixed to the bridge 8 or the frame 9 is perpendicular or substantially perpendicular to the wind direction during lift-off.

Advantageously, the first and second attachment means 23, 24 are movable, in particular pivoting around a vertical axis arranged substantially between the first and second means 23, 24, such that the axis passing through the means 23, 24 can be oriented relative to the wind direction.

Preferably, as illustrated on FIGS. 1 and 2, the floating craft or rolling and/or sliding land vehicle comprises a computer program product 100 comprising program code instructions recorded on a computer-readable medium for implementing the steps of the method which will be described below. Further preferably, the floating craft or rolling and/or sliding land vehicle comprises a data recording medium 101, computer-readable, on which a computer program is recorded which comprises program code instructions for implementing the method to be described below. The computer program product 100 comprises at least one signal 102 of the data medium 101.

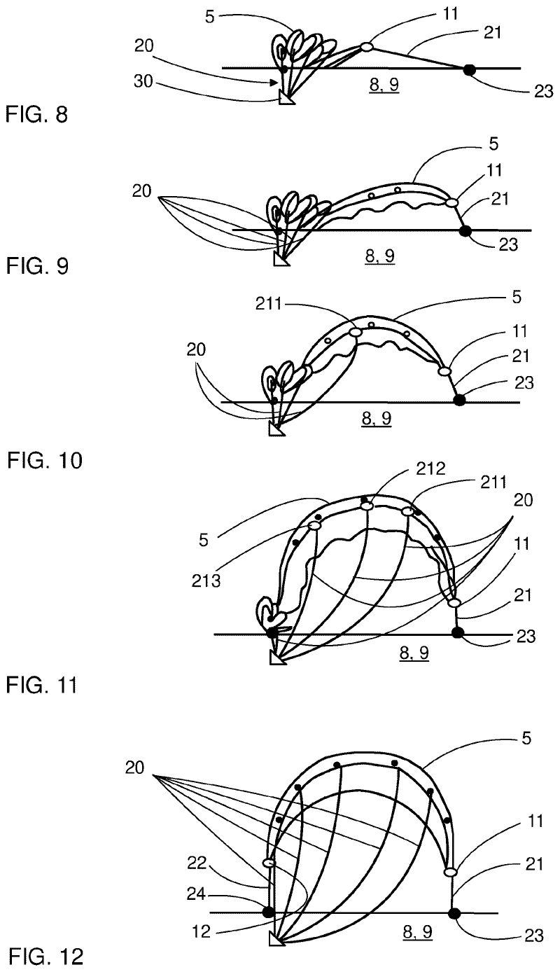

A mode for implementing a method of operation of the traction device 3 intended to cause lift-off of the sail 5 will now be described with reference to FIGS. 8, 9, 10, 11 and 12, illustrating the inflation and progressive lift-off by a wing of the sail. For example, the kite comprises a leading edge with closed boxes with single-skin upper surface and without straps.

Firstly, the sail 5 preferably remains folded, preferably in concertina fashion, for example in a bag or net (not shown), for example while being laid on the bridge 8 or frame 9. The launching line 20 is wound for example so that it can be unwound during the lift-off process. The first control line 21 connects the first attachment means 23 to the first anchoring point 11 of the sail 5. The second control line 22 connects the second attachment means 24 to the second anchoring point 12 of the sail 5. As a reminder, preferably the first and second lines 21, 22 pass through the first and second attachment means 23, 24, which are substantially aligned on an axis perpendicular to the wind and spaced apart by around two-thirds of the span of the kite. The second control line 22 is slack (since the part of the sail close to the second anchoring point will not be exposed to the wind until the end of launching or lift-off), and may be wound so as not to hinder the unwinding during the launching process. As illustrated on FIG. 8, the first control line 21 is taut or substantially taut. At least, the first control line 21 is not slack and retains the first anchoring point 11. The launching line 20, which connects the different attachment points 210 and the plate 30, is shortened as far as possible so as to keep the sail folded and partly held, for example in the bag.

The first control line 21 is pulled, which has the effect of deploying the sail 5 bit by bit by bringing the first anchoring point 11 closer to the first attachment point 23, at which the first control line 21 slides, as illustrated on FIGS. 8 and 9.

Thus the sail 5 is retained on the floating craft or on the vehicle via the first anchoring point 11 by the first control line 21, and the sail 5 is retained via at least the retaining point 211 closest to the first anchoring point 11, as illustrated in FIG. 10. It should be noted that the retaining point 211 is retained by the launching line 20, preferably via a crosspiece within the plate 30, as illustrated in FIG. 5. Thus FIGS. 8, 9 and 10 illustrate the main traction line or first control line 21, on the side opposite that of the bag, which line is tightened progressively and blocked pending complete lift-off. This has the effect of tightening, via the rigging lines 56, the end of the sail between the nearest retaining point 210 and the concentration plate 30.

Then the launching line 20 is unwound. The retaining points 211, 212, 213 of the sail 5, retained by the launching line 20, are progressively loosened so as to deploy the sail 5 bit by bit, allowing it to take the wind and/or inflate without jerking or high and/or sudden tension. In the case illustrated on FIGS. 7 to 12, the single launching line 20 runs forward and back between each retaining point and the plate 30. In fact, as shown above, the launching line 20 passes into the plate 30, joins and passes the retaining point 211, then joins the plate 30, then joins and passes the retaining point 212, then joins the plate 30, then joins and passes the retaining point 213, then joins the plate 30, then joins and passes the retaining point 214, then joins the plate 30, then joins and passes the retaining point 215, then joins the plate 30, then joins and passes the retaining point 216, then joins the plate 30. The term “joins” or “passes into” the plate 30 means that the line passes through the plate or draws closer to the level of the plate, e.g. via a spring hook or another sliding means allowing passage of the launching line 20.

Thus firstly, the retaining point 211 is loosened before loosening the retaining point 212, before loosening the retaining point 213, before loosening the retaining point 214, before loosening the retaining point 215, before loosening the retaining point 216. More precisely, a progressive loosening of the launching line is created step by step, maintaining a loosening at the retaining point 211 greater than that of the retaining point 212, itself greater than that of the retaining point 213, itself greater than that of the retaining point 214, itself greater than that of the retaining point 215, itself greater than that of the retaining point 216. Preferably, the friction of the launching line 20 at each retaining point and/or at the plate participates in controlling the progressive release of the retaining points.

In some cases, the loosening of the launching line 20 is controlled, for example, by an automatic friction means or by an automatic speed control means or by a manual means or by a brake.

Once all retaining points have been released by the unwinding of the launching line 20, the sail 5 is retained on the floating craft or vehicle by the first anchoring point 11 and by all retaining points, as illustrated on FIG. 11 (only three retaining points are illustrated).

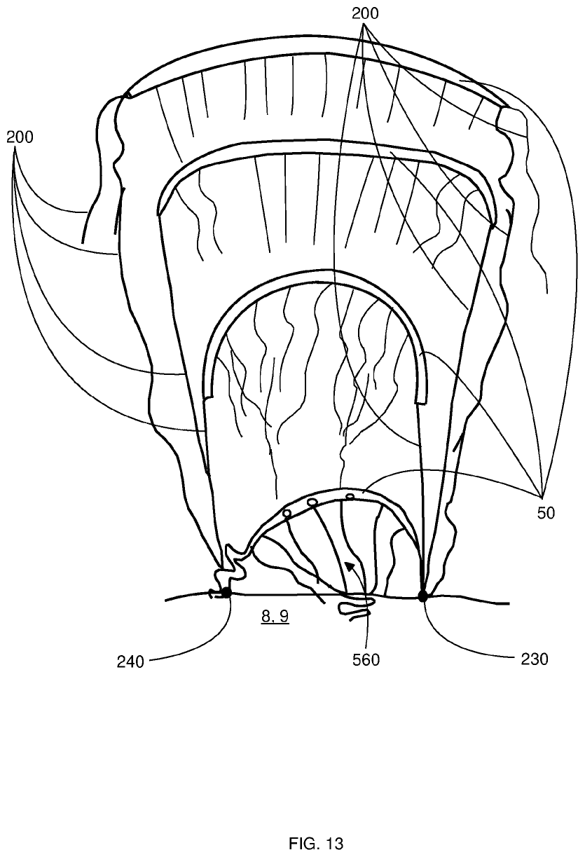

Then the sail is loosened so as to be progressively released at the retaining points, so that the sail inflates and/or lifts off. Preferably, the release is performed progressively, one retaining point after the other, moving away from the first anchoring point 11 and drawing closer to the second anchoring point 12, until the sail is retained only by the first and second anchoring points 11, 12. The sail 5 is retained by the first control line 21 on the first anchoring point 11, and by the second control line 22 on the second anchoring point 12, as illustrated on FIG. 12. The launching line 20 is then kept slack or jettisoned from the retaining points, if this is possible at the sliding means 220 provided at each retaining point.

Advantageously, to ensure recovery of the sail 5 after a flight and/or traction phase, the launching line 20 is pulled, in some cases after the second control line 22 has been pulled, so as to bring the retaining points closer together; then the first control line 21 is substantially slackened so as to allow recovery of the sail, e.g. at the second attachment means 24. Further advantageously, the sail is folded in the manner of a concertina such that the retaining points are close together, with a view to the next lift-off.

To summarize, as illustrated in FIGS. 3, 4 and 5, the positioning of the retaining points 210 or attachment points of the launch rigging lines, i.e. the points of connection of the launching line or lines to the sail, allow inflation and stable flight, in particular at great angles of attack. In addition, this positioning ensures lift-off of the sail 5 without disengagement. The distribution of the retaining points 210 along the length L, illustrated on FIG. 6, allows a homogeneous distribution of forces on the sail 5. This allows for example retention of a given sail shape during launching, and/or the avoidance of folds and/or breaks, in particular at the leading edge 6 of the sail 5. As a reminder, advantageously, the retaining points 210 are arranged behind or substantially behind the air intakes 55 relative to the wind direction V. Finally, the positioning of the retaining points 210 at the ribs and/or structural reinforcements allows the tension of the rigging lines to be transmitted towards the upper surface of the profile of the sail. The number of retaining points there is preferably for example a function of the size of the kite 4, in particular a function of the sail, in particular its length L or its span.

Preferably, as illustrated on FIGS. 7 to 12, a single launching line 20, i.e. a single rope or cord or bond is provided. Advantageously, as seen above, the launching line cooperates with the plate 30 which is preferably equipped with reeving means and/or holes or orifices. The cooperation of the plate with a single launching line allows the sail to lift off gently and homogeneously, piece by piece, while the length of the launching line gradually increases. For this, the length of the launching line is released, for example by unwinding if wound up, preferably via a loop 31 on the plate 30 (FIG. 7). Thanks to the distribution of the retaining points 211, 212, 213, 214, 215, 216 and of the launching line 20, cooperating therewith via the plate 30, the taking flight and/or lift-off and/or inflation of the sail 5 may take place piece by piece, for example without jerking. Furthermore, the plate and/or a reeving system allows a great reduction in the forces to be provided for gradually releasing the slack in the launching line. In other words, the reeving system allows limiting of the force intended to retain the launching line during lift-off of the sail 5, by multiplying the forces. A single person is then able to gradually release the launching line as required. In the case of automation, the actuator 32 requires only a low torque to gradually release the launching line 20. The result is a low energy consumption by such an actuator.

In other words, during the lift-off phase, the plate 30 allows a manual or mechanical loosening, in particular control of the sliding, of the rigging lines which can advantageously be grouped into a single continuous line.

As an alternative to a single launching line 20, each retaining point 211, 212, 213, 214, 215, 216 may be retained by a specific line. Consequently, with such a structure, the step of progressive loosening of the sail can be implemented differently. For example, the retaining point 211 can be completely loosened, then the retaining point 212 completely loosened, then the retaining point 213 completely loosened, then the retaining point 214 completely loosened, then the retaining point 215 completely loosened, and finally the retaining point 216 completely loosened. In this alternative, the sail is thus released progressively at the retaining points 210, so that it inflates and/or lifts off. The release is also performed progressively, retaining point after retaining point, moving away from the first anchoring point 11 and drawing closer to the second anchoring point 12, until the sail is retained only by the first and second anchoring points 11, 12.

Advantageously, as illustrated on FIG. 7, the plate 30 is substantially engaged on the first attachment means 23 or second attachment means 24, i.e. at or close to one of the main control and/or traction lines of the kite. The location of the plate is preferably determined as a function of the control line 21, 22 defined as optimal for the launch.

Thanks to this solution, at the start of deployment of the sail, the tension of the first control line 21 allows the or any air inlets to be presented to the wind, and/or the leading edge to be progressively inflated, as illustrated in FIGS. 9 and 10. Held in this way, the deformed profile of the sail, in particular behind the leading edge which may then shiver under the influence of the wind, allows a great angle of attack with low traction and excellent stability. By releasing the rigging lines alternately, or advantageously a single rigging line continuously, via the launching line 20, the kite progressively takes shape and lifts off as illustrated on FIGS. 11 and 12.

Alternatively, FIG. 13 schematically illustrates a variant of the launch sequence adapted to sails 50 retained by a set of rigging lines with linked lift-off ties. Two traction or launching lines 200, each fixed to one end of each wing of the sail 50, allow progressive gaining of altitude with lateral auto-stability resulting from the spacing of the two attachment means 230, 240 or traction points on the craft or land vehicle, and from the deformed profile, until the traction lines for the main retention are taut and operational. The two traction lines 200 for the lift-off may advantageously be jettisoned after use.

Although all rigging lines or temporary ties 560 intended for inflation and lift-off may be retracted after use, they may advantageously remain in place and allow the descent, landing and partial folding of the sail by progressive retightening thereof.

To summarize, the solution concerns a system of additional rigging lines which are preferably connected to the same launching line, are permanent or temporary, and can be used for all types of kite, e.g. flexible with boxes, with single skin, double surface, open or closed boxes, held or not by straps. The solution allows easy deployment of the sail from the ground or from the bridge of the ship, and/or allows recovery while providing auto-stability. Such a stability inherent in the kite allows limitation or even elimination of the need for steering.

Thanks to the solution, a sail of a kite having a large surface area may lift off easily. Also, the forces for creating lift-off, e.g. generated manually, are small. Furthermore, the actions are simple to perform. The result is an increased safety, in particular during the lift-off phase. Finally, the solution guarantees an improved stability of the kite, in particular during the inflation and lift-off phase.

It should be noted that the solution thus achieves the desired objective of facilitating inflation and launching of the kite, in particular intended to pull along a floating craft, while improving the stability and safety in this critical phase of take-off, but also the recovery of the kite, and offers the following advantages:
it is economic,
it is simple to implement on a craft or land vehicle.

1. A sail for a kite of a traction device for pulling along a floating craft or a rolling and/or sliding land vehicle, wherein:
the sail extends over a length, and
the sail comprises retaining points intended to cooperate with a launching line to facilitate lift-off of the sail.

2. The sail as claimed in claim 1, wherein the retaining points are distributed along the length of the sail.

3. The sail as claimed in claim 1, wherein the sail comprises a leading edge and the retaining points are arranged in a lower zone of the leading edge.

4. The sail as claimed in claim 1, wherein the sail comprises a sliding means for a launching line at each retaining point.

5. The sail as claimed in claim 1, wherein the sail comprises a first anchoring point of the sail and a second anchoring point of the sail.

6. A traction device for pulling along a floating craft or a rolling and/or sliding land vehicle, the traction device comprising:
the sail as claimed in claim 5,
a launching line,
a first control line of the sail connected to the first anchoring point of the sail, and
a second control line of the sail connected to the second anchoring point of the sail,
wherein the launching line passing passes through each of the retaining points and/or is fixed in jettisonable fashion to each of the retaining points.

7. A traction device for pulling along a floating craft or a rolling and/or sliding land vehicle, comprising:
the sail as claimed in claim 5,
a single launching line,
a first control line of the sail connected to the first anchoring point of the sail, and
a second control line of the sail connected to the second anchoring point of the sail,
wherein the single launching line passes through each of the retaining points and/or is fixed in jettisonable fashion to each of the retaining points.

8. A traction device for pulling along a floating craft or a rolling and/or sliding land vehicle, comprising:
the sail as claimed in claim 5,
a single launching line,
a first control line of the sail connected to the first anchoring point of the sail,
a second control line of the sail connected to the second anchoring point of the sail,
the single launching line joining each of the retaining points.

9. The traction device as claimed in claim 6, wherein the traction device comprises a plate comprising at least one pulley block and/or holes through which the launching line passes.

10. A floating craft comprising the traction device as claimed in claim 6, wherein the floating craft comprises a bridge comprising a first means for attaching the first control line and a second means for attaching the second control line, the first attachment means and the second attachment means being spaced apart from one another by a given value.

11. A rolling and/or sliding land vehicle comprising the traction device as claimed in claim 6, wherein the rolling and/or sliding land vehicle comprises a frame comprising a first means for attaching the first control line and a second means for attaching the second control line, the first attachment means and the second attachment means being spaced apart from one another by a given value.

12. A method of operation of the traction device as claimed in claim 6, the method comprising:
retaining the sail on the floating craft or on the vehicle via the first anchoring point and via at least the retaining point closest to the first anchoring point,
loosening the sail to progressively release the sail at the retaining points so that the sail inflates and or lifts off, the release being achieved progressively, one retaining point after another retaining point, moving away from the first anchoring point and drawing closer to the second anchoring point, until the sail is retained only by the first and second anchoring points.

13. The method as claimed in claim 12, wherein the loosening is controlled by at least one of the following: an automatic friction means, an automatic speed control means, a manual means, a brake.

14. A traction device comprising hardware and/or software elements adapted to implement the method as claimed in claim 12.

15. A computer program product comprising program code instructions recorded on a computer-readable medium adapted to implement the method as claimed in claim 12 when the program runs on a computer.

16. A data recording medium, readable by a computer, on which a computer program is recorded which comprises program code instructions for implementing the method as claimed in claim 12 when the program runs on the computer.

17. The computer product program as claimed in claim 15, wherein the computer program product is downloadable from a communication network.

18. The sail as claimed in claim 1, wherein the sail is a flexible sail with boxes.

19. The sail as claimed in claim 1, wherein the sail has a single skin.

20. The sail as claimed in claim 1, wherein the sail has rigging lines or straps which distribute a traction force over a plurality of points attached to the lower surface of the sail.
